(19) United States
(12) Patent Application Publication
(10) Pub. No.: US 2008/0209441 A1
(43) Pub. Date: Aug. 28, 2008

(54) Context-driven dynamic subscription based on user selections

(76) Inventors: Daven Walt Septon, Fort Wayne, IN (US); Bryan F. Carpenter, Loveland, CO (US)

Correspondence Address: Gregory W. Osterloth;Holland & Hart, LLP, P.O. Box 8749, Denver, CO, 80201, US

(21) Appl. No.: 11/711,512

(22) Filed: Feb. 27, 2007

(51) Int. Cl. G06F 9/44

(52) U.S. Cl. 719/318

(57) ABSTRACT

Methods and systems for allowing dynamic subscription updates by an event notification service are presented.

### BACKGROUND OF THE INVENTION

The present invention relates generally to configuring computer systems, and more particularly to a method and apparatus for dynamically changing user subscription lists based on user selections in a graphical user interface.

In computer systems and other industrial equipment or systems, data relating to the purpose, functionality, and/or performance of the system is generated in electronic format. This data may be used or processed by other computerized systems, called “subscribers”. Subscribers may be independent hardware and/or software systems, or may be processing components such as software executing within the same system that generates the electronic data. The electronic data generated by a system may be utilized in different ways and for different purposes by different subscribers of the data. Furthermore, different subscribers may utilize different parts of the electronic data or even different sub-parts of the data.

Electronic data generated by a system typically comprises a plurality of different pieces of information relating to an item of data. For example, in a manufacturing line, measurements may be made on the items being manufactured for purposes of quality control. Each measurement may have associated with it not only the measurement value, but also other information associated with the measurement such as item serial number from which the measurement was made, time of measurement, measurement identifier which indicates the particular measurement made, manufacturing line identifier, tester identifier, test operator identifier, etc. Typically, pieces of information associated with an item of data are packaged into a data packet. The individual pieces of information associated with the item of data may be stored in fields. For purposes of convenience, an item of electronic data shall be referred to herein as an “event”, and the individual pieces of information associated with the event shall be referred to herein as “fields” of the event. While conceptually an event comprises a number of fields, the particular packaging of the fields which make up the event may not be as straightforward as merely appending each field into a fixed length data package. In practice, the individual fields may be interspersed or combined with other fields, and/or may be encrypted, such that only by performing a specific extraction function can the individual field values be extracted from an event. For simplicity of description, fields of an event shall be illustrated as being readily identifiable portions of the data package that makes up the event. However, it is to be understood that the fields are to be extracted from an event using appropriate respective function(s) required for reliable extraction of each of the individual fields.

Subscribers of events generated by an event-generating system each rely on the events, yet may perform different functions based on the event data. Subscribers of events may also use different subsets of events generated by the event-generating system, and/or may use different subsets of the fields of the events they subscribe to.

For performance purposes, it is clearly desirable to minimize the amount of unused event data sent to subscribers. Accordingly, many systems implement a subscription model which allows subscribers to subscribe only to those events which they actually utilize. This capability is typically implemented in the form of setting and updating a subscription list associated with the subscriber. A simple subscription list may allow a subscriber to subscribe to (and hence receive only those) events of a particular type (e.g., particular measurement types, or system event occurrences, etc.). More sophisticated subscription lists would preferably allow a subscriber to subscribe not only to events of a particular type, but also only to particular fields of the event. This type of subscription list implementation would minimize the amount of unused data sent to a given subscriber. As used herein, a “subscription list” is a list of event types and associated event fields that a given subscriber subscribes to—that is, in the packet example, those fields of a data event that are necessary or configured for use by the given subscriber. A subscription list is associated with one or more subscribers.

In operation, an event notification service (which may be implemented as software and/or hardware either within or remote from a given event-generating system), monitors events generated by the event-generating system, and notifies only those subscribers that subscribe to the particular event, as indicated in the respective subscriber lists of the respective subscribers. Notification may be in the form of a message to a subscriber that an event is available for pickup by the subscriber. Alternatively, the event notification service may send the actual event data to a subscriber which includes only those events and respective event fields to which the subscriber subscribes as identified in the subscriber's associated subscription list.

Systems which implement some form of an event subscription model typically allow the subscriptions to be configured at start-up. When a subscriber registers with an event notification service, it makes its associated subscription list available to the event notification service. The event notification keeps track of which events and event fields are subscribed to by each subscriber. However, subscription services do not allow dynamic subscription changes. Instead, in current systems, a subscription list associated with a given subscriber is read once at the time of registration of the subscriber with the event notification service. If changes in the content of the subscription is desired for a given subscriber, the subscriber must re-register with event notification service to get the event notification service to reconfigure the events subscribed to by the subscriber. Typically, this requires a shutdown and restart of the event notification service to get it to pick up the new subscription list. Thus, if it is desired to allow dynamic subscription list changes, then current systems allow only two alternatives: 1) restart the event notification service to get it to pick up the new subscription list, or 2) the subscription list must subscribe to all notifications, requiring the use of system resources for unwanted data. Both of these alternatives interfere with achieving maximum system performance, since for the first alternative requires reboot time, and the second alternative allocates processor time and resources to moving data that ends up never being used by a given subscriber.

Accordingly, a less disruptive, less time-consuming, and higher-performance technique for allowing dynamic subscription list change is needed.

### SUMMARY OF THE INVENTION

Embodiments of the invention includes techniques for allowing dynamic subscription updates in an event notification service.

In one embodiment, an event notification system comprises a subscription manager which keeps track of respective subscriptions of at least one subscriber, the subscription manager configured to receive a subscription update request from a requesting subscriber and to update the respective subscription associated with the requesting subscriber with a requested subscription; an event monitor which receives an event; and an event notifier configured to notify any subscribers having a subscription to the received event.

In one embodiment, a method for allowing dynamic subscription updates by an event notification service comprises: maintaining respective subscriptions of at least one subscriber; receiving a subscription update request from a requesting subscriber; and updating the respective subscription associated with the requesting subscriber with a requested subscription update.

In one embodiment, the method is implemented in executable form on a computer readable storage medium.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of an embodiment of a system implementing an event notification service that allows dynamic subscription capability;

FIG. 2A is a flowchart of an embodiment of a method for allowing subscription updates in an event notification service;

FIG. 2B is a flowchart of an embodiment of a method for updating a subscriber's associated subscription;

FIG. 2C is a flowchart of a method for allowing subscription updates in an event notification service;

FIG. 3 is a block diagram of an embodiment of a test environment which utilizes an event notification service with subscription update capability;

FIG. 4 is a screen view of an embodiment of a window display having subscription update capability;

FIG. 5 is a screen view of an embodiment of a window display including a display options dialog;

FIG. 6 is a screen view of an embodiment of a window display showing changes in the display options dialog; and

FIG. 7 is a screen view of an embodiment of a window display with the changes in the display option of FIG. 6 applied.

### DETAILED DESCRIPTION

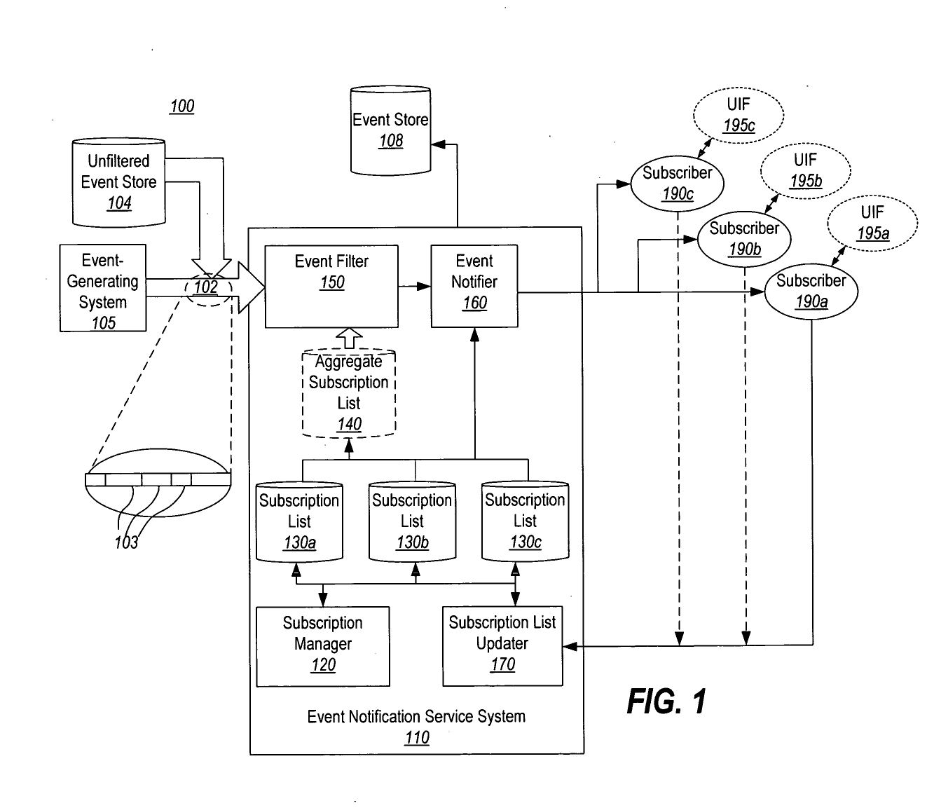

Turning now to the drawings, FIG. 1 is a high-level architectural diagram of an embodiment of a system implementing an event notification service that allows dynamic subscription capability. In particular, FIG. 1 illustrates a system 100 that includes an event-generating system 105. The event-generating system 105 generates electronic data in the form of events 102. As described in the background section, events include a number of individual fields 103 associated with the event. Events 102 may be stored in a database 104, such as a file.

A number of subscribers 190a, 190b, 190c may subscribe to all or a subset of events 102 and all or subsets of the event fields 103 of the subscribed-to events by way of registration with an event notification service 110. An event notification service 110 keeps track of subscriber's 190a, 190b, 190c individual subscriptions and notifies respective subscribers 190a, 190b, 190c upon receipt of events 102 that match the respective subscriber's subscription. In one embodiment, the event notification service 110 maintains a subscription list 130a, 130b, 130c for each subscriber 190a, 190b, 190c served by the event notification service 110. A subscription manager 120 may aggregate the subscription lists 130a, 130b, 130c into an aggregate subscription list 140 which contains a list of all events and fields of the events subscribed to by any of the served subscribers 190a, 190b, 190c.

An event filter 150 receives events 102 either directly from the event-generating system 105 or from an unfiltered event store (e.g., a file) 104 into which the events 102 are deposited by the event-generating system 105. The event filter 150 filters the received events 102 and may discard any event 102 and/or event fields 103 that are not subscribed to by any of the subscribers 190a, 190b, 190c that it serves. In one embodiment, the event filter 150 filters out (i.e., discards) all events and event fields that are not designated in the aggregate subscription list 140 as being subscribed-to by any of the served subscribers 190a, 190b, 190c. In another embodiment, the event filter 150 accesses each of the subscription lists 130a, 130b, 130c to determine which events 102 and event fields 103 to retain for the subscribers 190a, 190b, 190c. The retained event data may be stored in an event store 108.

An event notifier 160 notifies respective subscribers 190a, 190b, 190c when events that are subscribed to by the respective subscriber 190a, 190b, 190c are available. In one embodiment, the event notifier 160 may send a message to the subscriber indicating that subscribed-to event data is available for pickup from an event store 108. In an alternative embodiment, the event notifier 160 may send the subscribed-to events directly to the subscriber.

The event notification service 110 includes a subscription list updater 170 which allows subscribers to set and dynamically change their subscription to events and event fields while the event notification service 110 is in service. In one embodiment, the event notification service 110 requires subscribers 190a, 190b, 190c to register with the service 110 in order to receive notification of events. During the initial registration, the subscription manager 120 may create a subscription list 130a, 130b, 130c associated with the subscriber 190a, 190b, 190c. The subscription list 130a, 130b, 130c may be initialized with a subscription to all events and all event fields. The subscriber 190a, 190b, 190c may then invoke the subscription list updater 170 to set its subscription (i.e., the contents of its respective subscription list 130a, 130b, 130c) to an initial configuration. When invoked, the subscription list updater 170 updates the contents of the invoking subscriber's subscription list 130a, 130b, 130c to reflect the updates. Updates may be additions or deletions of events and/or event fields.

The subscription list updater 170 may also be invoked by a subscriber after its initial registration with the event notification service 110 to allow dynamic changes to its subscription list without having to re-register the subscriber 190a, 190b, 190c. Thus, the subscription list updater 170 may be invoked at any time while the event notification service 110 is operating. This allows subscribers 190a, 190b, 190c to make changes to subscription configuration choices at runtime that alter the kinds of data that are required by the subscriber. The subscriber's updated subscription selection “ripples up” the data stream to enable processing and storage of events that are now being requested, and to disable the processing and storage of event data that is no longer subscribed to.

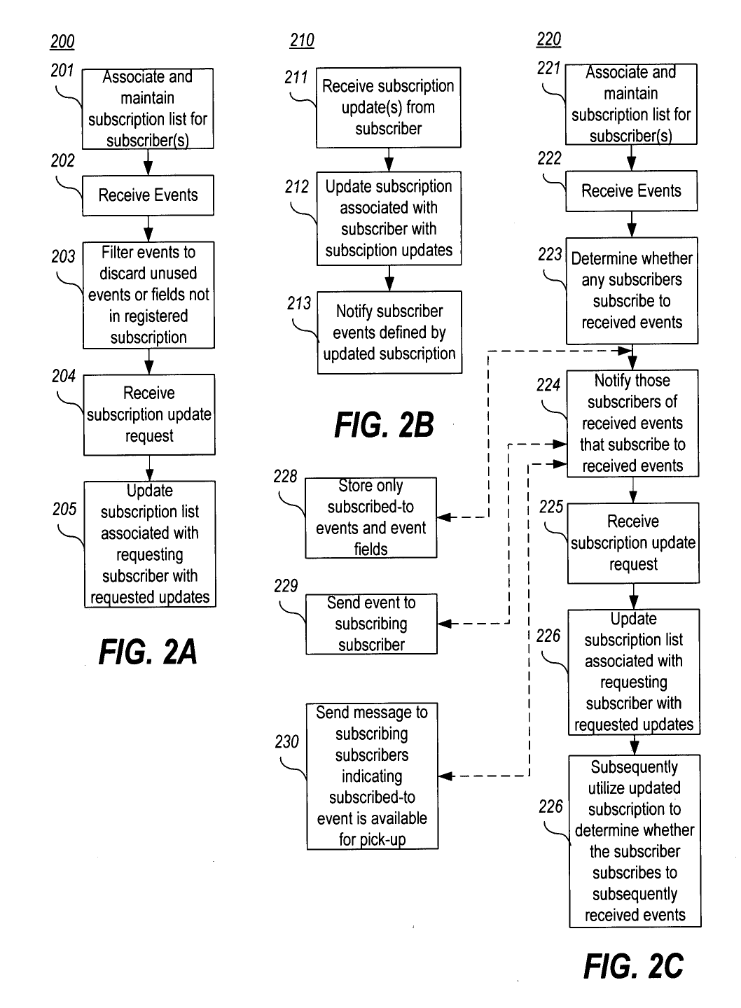

FIG. 2A is a flowchart illustrating an embodiment of a method 200 for allowing dynamic subscription list updates by an event notification service which serves events generated by an event-generating system to subscribers. The method 200 includes the steps of maintaining at least one subscription list associated with at least one respective subscriber to the events (step 201); receiving events (step 202); filtering the events to discard unused events and/or unused event fields not subscribed to in any of the maintained subscription lists (step 203); receiving a subscription list update request from a requesting subscribe (step 204); and updating the respective subscription list associated with the requesting subscriber with the subscription list update (step 205).

FIG. 2B is a flowchart illustrating an embodiment of a method 210 for allowing dynamic subscription list updates by an event notification service which notifies subscribers of events to which the subscribers subscribe. The method 210 includes the steps of receiving subscription updates from a subscriber (step 211); updating a subscription associated with the subscriber with the subscription updates (step 212); and notifying the subscriber of events defined by the updated subscription (step 213).

FIG. 2C is a flowchart illustrating an embodiment of a method 220 for notifying subscribers of events to which the subscribers subscribe. The method 220 includes the steps of maintaining a subscription associated with each subscriber, the subscription defining events to which the associated subscriber subscribes (step 221); receiving events (step 222); determining, based on the subscriptions, whether any of the subscribers subscribe to the received events (step 223); notifying subscribers that subscribe to the received events of the received events (step 224); receiving subscription updates from a subscriber (step 225); updating the subscription associated with the subscriber with the subscription updates (step 226); and subsequently utilizing the updated subscription to determine whether the subscriber subscribes to subsequently received events (step 227).

In one embodiment, only events which are subscribed to by a subscriber may be stored (step 228). Notification to subscribers may be by sending the events to the subscribers (step 229). Notification to subscribers may be by sending a message to the subscribers that the events are available for access in an event store (step 230).

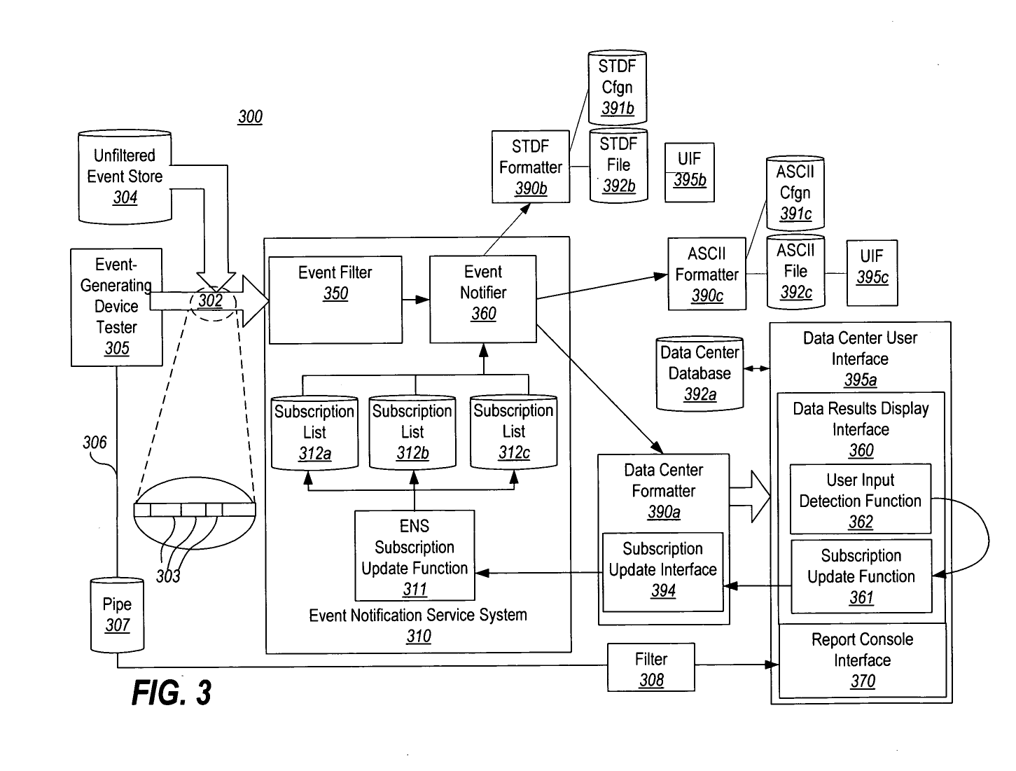

FIG. 3 is a block diagram of an embodiment of a test environment 300 which utilizes an event notification service 310 with dynamic subscription list updating capability to allow dynamic display configuration in client user interfaces. The test environment 300 includes a device tester 305 which executes tests on devices under test (for example, an integrated circuit tester which performs in-circuit and functional tests on integrated circuit devices). (Note: While presented herein as a device tester 305, it is to be understood that the device tester 305 may alternatively be any other event-generating device that generates events to be displayed on a screen by a user interface.) The tester 305 generates events 302 of various types. For example, tester events 302 may include events types such as a message event type, a measurement event type, a system status event type, and so on. Each event may include a number of event fields 303 each of which includes information associated with the particular event. For example, a message event may include an event type field identifying the event as a message event, a time field which identifies the time of the message, a system identifier which identifies the system to which the message applies, a message field which stores the message, etc. A measurement event may include an event type field identifying the event as a measurement event, a time field which identifies the time of the measurement, a system identifier which identifies the system from which the measurement was made, a test identifier which identifies the test type, a measurement value which contains the actual measured value, etc. A system status event may include an event type field identifying the event as a system status event, a time field which identifies the time of the status, a system identifier which identifies the system to which the status applies, a status field which indicates the identified system's status, etc. The types of events and the numbers and sizes of the fields for each event type may vary from system to system.

The events 302 generated by the tester 305 may be stored in an unfiltered event store 304. For example, tester events 302 may be stored in a file formatted according to a particular format standard (such as EDL (Event Description Language) format).

An event notification service 310 receives events 302 either directly from the tester 305, or from an event store 304 (such as an EDL file). The event notification service 310 serves a number of data formatters 390a, 390b, 390c which operate to format the event data into specific formats required by respective user interfaces 395a, 395b, 395c. The user interfaces 395a, 395b, 395c are independent interfaces used for retrieving and displaying events data. For example, a user interface 395b may require data formatted according to a well-known universal standard STDF format, whereas a user interface 395c may require data formatted according to a well-known universal standard ASCII format. Yet another user interface 395a (also referred to herein as a “Data Center user interface 395a”) may require data formatted according to a customized format used by a user interface 395a.

The event notification service 310 allows any number of different data formatters 390a, 390b, 390c to subscribe to any of the events 302 received by the event notification service 310. While some formatters (e.g., in this embodiment, the STDF formatter 390b and the ASCII formatter 390c) may serve user interfaces that do not support dynamic display configuration changes after registration of the formatter 390b, 390c with the event notification service 310, other formatters (e.g., in this embodiment, the Data Center formatter 390a) may support dynamic display configuration changes.

The event notification service 310 includes event filtering tasks which include the implementation of a subscription service. In this regard, formatters 390a, 390b, 390c subscribe to events 302 and the event notification service 310 filters the data based on the subscriptions of each formatter. In one embodiment, the event notification service 310 maintains a respective subscription list 312a, 312b, 312c for each registered formatter 390a, 390b, 390c. The subscription list 312a, 312b, 312c indicates to the event notification service 310 which events 302 and event fields 303 should be routed (by way of a notification message, or by actual data transfer) to which formatter 390a, 390b, 390c. For maximum storage and processing efficiency, the event notification service 310 may discard all events 302 and event fields 303 that are not subscribed to by any of the served formatters 390a, 390b, 390c.

Each formatter 390a, 390b, 390c receives only events and event fields that it subscribes to. A formatter's subscribed-to events may be stored in an event store 392a, 392b, 392c associated with the user interface 395a, 395b, 395c. The user interface 395a, 395b, 395c may utilize its respective event store 392a, 392b, 392c to populate events displayed on a respective display screen. As a user of a given user interface 395a, 395b, 395c scrolls through events displayed on a display screen, the given user interface 395a, 395b, 395c may remove event data from the screen that is no longer within the scrollbar view, and then accesses event data stored in its respective event store 392a, 392b, 392c to populate event data falling within the scrollbar view that is newly visible due to a scrollbar position change.

Event notification service 310 includes subscription capability that allows the formatters 390a, 390b, 390c to subscribe to certain events and event fields. In one embodiment, when a formatter 390a, 390b, 390c registers with the event notification service 310 as a subscriber, a subscription list 312a, 312b, 312c is created and associated with the newly registered subscriber 390a, 390b, 390c. The event notification service 310 filters events 302 to discard any event 302 and/or event field 303 not subscribed to in at least one of the subscription lists 312a, 312b, 312c associated with registered subscribers 390a, 390b, 390c. The event notification service 310 also utilizes the subscription lists 312a, 312b, 312c to know which subscriber(s) to notify of events, or to which to send the retained event data.

In one embodiment, a formatter 390b, 390c may have a respective associated configuration file which contains parameters or other information that may be read or parsed by the event notification service 310 to determine which event(s) and event field(s) that the respective formatter 390b, 390c, subscribes to. For example, the STDF formatter 390b and the ASCII formatter 390c may each have an associated configuration file 391b, 391c which is accessed by the event notification service 310 when the respective formatters 390b, 390c are registered with the service 310. A configuration file 391b, 391c may be parsed by the event notification service 310 to set up a subscription list 312b, 312c associated with the particular formatter 390b, 390c.

In conventional event notification services, a given subscriber's subscription list 312b, 312c cannot be dynamically changed once the subscriber is registered with the service 310. In embodiments described herein, however, the event notification service 310 supports dynamic subscription update capability, which means that the event notification service 310 allows changes to subscriber subscription lists even after initial registration of the corresponding subscriber. In one embodiment, the event notification service 310 includes an event notification service (ENS) subscription update function 311. The ENS subscription list update function 311 may be invoked by any subscriber to initialize or make changes (updates) to their respective subscriptions. Correspondingly, a subscriber that supports dynamic subscription changes must include a subscription update interface configured to invoke the ENS subscription update function 311. It will be noted that if a subscriber supports dynamic subscription list update capability, the formatter may not need a subscription configuration file.

For example, formatter 390a may be a customized formatter which supports a user interface 395a (or “Data Center user interface 395a”) that allows dynamic subscription change capability. In this example, both the formatter 390a and the event notification service 310 implement tasks that allow the formatter 390a to make changes to the subscription associated with the formatter 390a. In this example, the event notification service 310 is configured with an ENS subscription update function 311, and the Data Center formatter 390a is configured with a subscription update interface 394. The subscription update interface 394 of the Data Center formatter 390a may invoke the ENS subscription update function 311 to change the Data Center formatter's subscription. In one embodiment, the ENS subscription update function 311 changes the contents of the invoking formatter's associated subscription list that is maintained and used by the event notification service 310 to determine which events 302 and event fields 303 that the invoking formatter subscribes to.

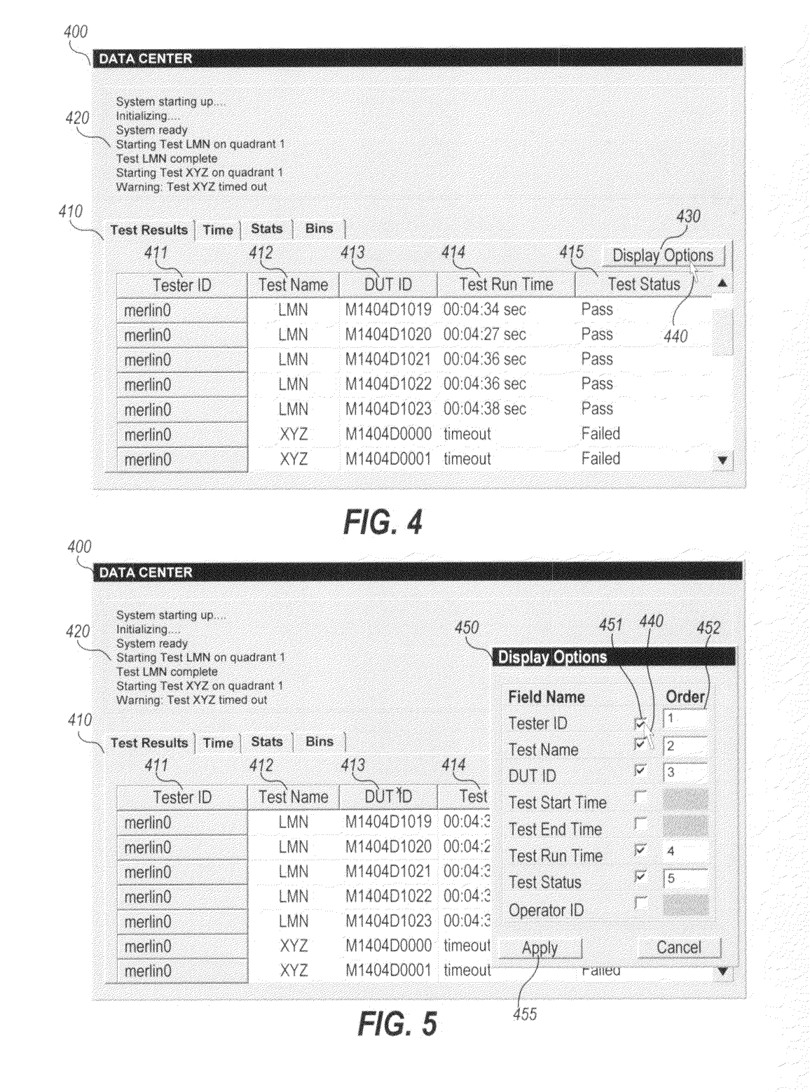

The Data Center user interface 395a is a user interface which presents event data on a screen (for example, in the embodiment shown in FIG. 4). The Data Center user interface 395a may include a data results display interface 360. The data results display interface 360 receives subscription events from event store 392a (which is populated from the Data Center formatter 390a) or directly from the data center formatter 390a.

The Data Center user interface 395a may also include a Report Console interface 370. The Report Console interface 370 may receive system information 306 from the tester 305 and display the system information in a report console pane 420 (FIG. 4) on a window 400 of a display screen for viewing by a user. Such system information 306 may include, but is not limited to, error messages, warnings, and general messages that may or may not be included in the events 302. In one embodiment, the report console interface 370 receives system information 306 by way of a Unix “pipe” 307 a standard Unix method of sending information between various software processes). The piped information may be manipulated and routed by a filter 308. For example, the filter 308 may perform some text manipulation before directing piped text or other information to the Data Center 395a. The filter 308 may also determine where the piped text should be displayed on a display screen (not shown) and route it appropriately. Text manipulation might include color highlighting, small icons for errors, etc.

The data results display interface 360 displays event data to a user in a display configuration format defined by the current subscription. For example, as shown in the embodiment in FIG. 4, the screen presented to the user on a display includes a Data Center window 400 having a Data Results pane 410 which displays event data according to a user-specified format. In the embodiment shown, subscription test result events 302 from the tester 305 are displayed in a tabular format, wherein each column 411 through 415 corresponds to a particular field 303 of a measurement data type event 302, or to a derivation of a combination of multiple fields 303 of one or more events 302. In the example shown, the display configuration is set to display, in columns from left to right, the tester ID 411, the test name ID 412, the device under test (DUT) ID 413, the test runtime 414, and the test status (pass/fail) 415. In this embodiment, in order for the Data Center 395a to populate the Data Results pane 410 with the specified event data, the Data Center user interface 395a must instruct the Data Center formatter 390a to subscribe to events 302 of type “measurement” and corresponding event fields including “tester ID”, “Test Name”, “DUT ID”, “Test Start Time”, “Test End Time”, and “Test Status”. Note that there is no corresponding field 303 corresponding to “Test Run Time”; however the “Test Run Time” event data is calculated, or derived, by subscribing to the “Test Start Time” field and the “Test End Time” field and calculating the difference.

A given display configuration such as that shown in FIG. 4, may be set as a default display configuration, wherein the subscription list 312a maintained by the event notification service 310 is initialized to the default display configuration during registration of the Data Center formatter 390a with the event notification service 310, or may be actively set by the user using the user interface mechanisms 430 such as a display configuration dialog, accessible from the Data Center window 400. In one embodiment, display configuration options may be selected in a pop-up menu 450 (shown in FIG. 5), accessed by selecting a Display Options button 430 with a mouse pointer 440 and clicking on the mouse (not shown).

For example, when the Display Options button 430 shown in FIG. 4 is clicked on or otherwise activated using means well-known in the art, a pop-up menu may be displayed to present event data options and event data order options. In one embodiment, as illustrated in FIG. 5, the pop-up menu 450 includes event data names with associated checkboxes 451. A check in a checkbox 451 indicates that corresponding event data will be displayed (and therefore the one or more fields used to generate the corresponding event data are subscribed to), and an empty checkbox 451 indicates that the corresponding event data will not be displayed (and therefore the one or more fields used to generate the corresponding event data are not subscribed to). The user may check the box using input means well-known in the art, such as by way of selection of a checkbox 451 with a mouse pointer 440 followed by a mouseclick. The order of the checked event data names to be displayed in the Data Results pane 410 (in order from left to right) may be set by entering the number of the desired position (from left to right) to be associated with the respective checked event data name.

The Data Results display interface 360 includes a user input detection function 362 that monitors the user input mechanisms 430, 450 to receive user input, such as display configuration changes. The Data Results display interface 360 also includes a subscription update function 361. The subscription update function 361 interacts with the Data Center formatter 390a to let the formatter 390a know which events 302 and event fields 303 to subscribe to. When the user input detection function 362 detects user input, it acquires the input and invokes the event subscription update function 361 of the Data Center formatter 360. The subscription update function 361 invokes the subscription update function 394 of the Data Center formatter 390a, which in turn invokes the ENS subscription list update function 311 of the event notification service 310 to update the Data Center's subscription. Thus, the user can interact with the Data Center user interface 395a and may “request” more or less data than that currently being displayed.

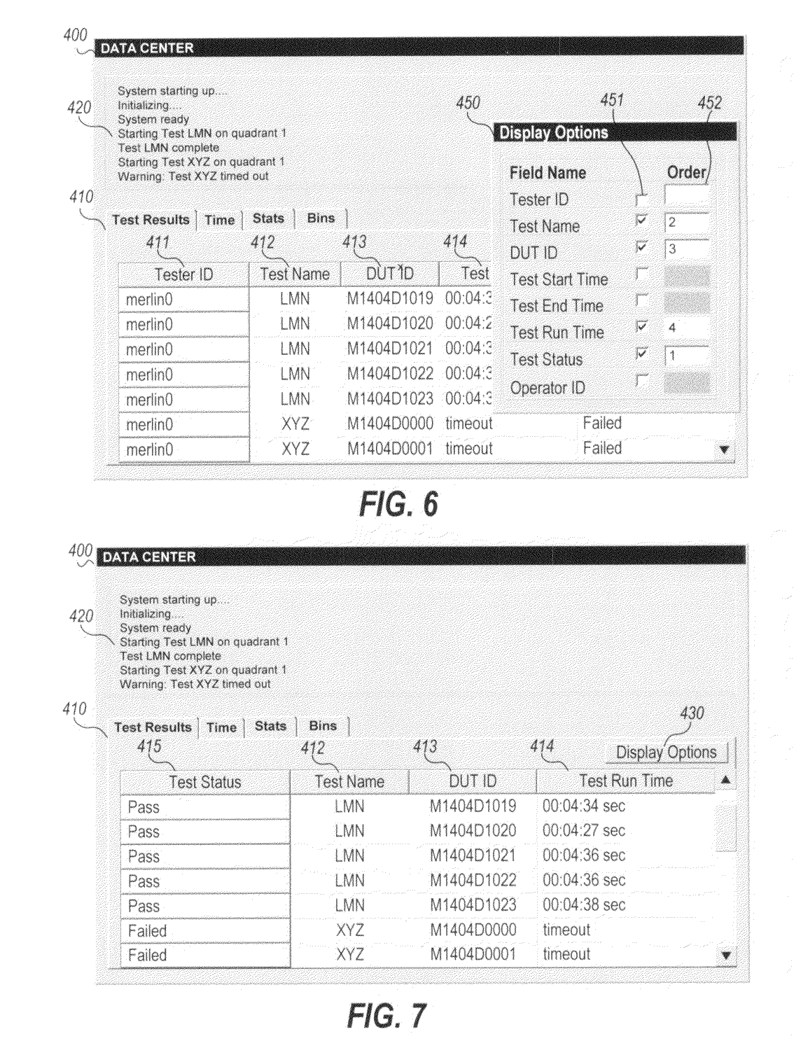

For example, suppose the user desires to change the display format, and therefore the subscription, of the Data Center 400 presented by the Data Center user interface 395a. In particular, with reference to FIG. 6, suppose the user desires to remove the Tester ID field 411 from the display and to reposition the fields of the display to “Test Status”; “Test Name”, “DUT ID”, and “Test Run Time”, from left to right. To do this, the user activates the Display Options button 430 on the Display Results pane 410 (FIG. 4), and then unchecks the Tester ID field checkbox, and reorders the numbers of the fields to “1” for Test Status field, “2” to Test Name field, “3” to DUT ID field, and “4” to Test Run Time field. The user then activates the Apply button 455. The resulting display is shown in FIG. 7.

The Data Center user interface 395a may allow other mechanisms for the user to change the display configuration format. For example, the Data Center user interface 395a may provide input functionality which allows a user to perform a drag-and-drop function to change the positions of the displayed columns. This type of functionality is well-known in the art. The Data Center user interface 395a may also provide input functionality which allows a user to right-click (using a mouse) on a column and be presented with the option to delete the column (and hence unsubscribe to the field 303 that populates the column). Other input mechanisms may be implemented without departing from the functionality of the invention.

In more detailed operation, the tester 305 generates data in the form of events 302, which may comprise a number of event fields 303. The event notification service 310 receives events 302. The event notification service 310 is started up and placed in a running state (i.e., the event notification service 310 is “spawned”). Formatters 390a, 390b, 390c that are to receive event data from the tester 305 are spawned. During startup of a formatter, the formatter registers with the event notification service 310. During the registration process of a formatter 390a, 390b, 390c, the event notification service 310 creates and associates a subscription list with the registering formatter. In one embodiment, a subscription list 312b, 312c is initialized to a subscription specified in a configuration file 391b, 391c associated with the formatter. If the formatter 390a does not have an associated configuration file, its subscription list 312a is initialized to subscribe to all events 302 and all event fields 303. In this embodiment, the registering formatter 390a must actively request the event notification service 310 to change its initial subscription list 312a if it desires to subscribe to less than all events 302 and event fields 303. The event notification service 310 includes a subscription list update function 311 which registering formatters 390a, 390b, 390c may invoke to make changes to its subscription list.

The event notification service 310 then receives events 302 and sends events 302 and/or event fields 303 that match a subscription in at least one of the subscription lists 312a, 312b, 312c to respective subscribing formatters 390a, 390b, 390c. The formatters 390a, 390b, 390c utilize the subscription event data according to their own specific purpose.

A formatter 390a may request updates to its subscription (e.g., its subscription list 312a). In the example shown in FIG. 3, the Data Center user interface 395a supports dynamic subscription updates. The dc user interface 395a spawns a display interface 360 to monitor and detect user input in the form of subscription update requests. Upon input of a subscription update request, the display interface 360 invokes the subscription update interface 394 of the Data Center formatter 390a, passing it the subscription updates. The subscription update interface 394 then invokes the ENS subscription' update function 311 of the event notification service 310, which receives the subscription updates and updates the subscription list 312a associated with the Data Center formatter 390a with the received subscription updates. Upon further receipt of events 302, the event notification service 310 then filters the events 302 for the Data Center formatter 390a according to the updated subscription list 312a.

So far, subscription changes that request less data than currently subscribed to have been described in conjunction with FIGS. 4 through 7. Subscription changes that request more data than currently subscribed to may be implemented in a similar manner, with immediate updating of the subscription list 312a in the event notification service 310 upon request by a user through the Data Center user interface 395a. In many situations, immediate display update may be appropriate, wherein any data to be displayed that is missing due to its not being previously subscribed to is merely shown as blank or with a symbol indicating that the data is unavailable.

However, in some applications, it may be inappropriate to update a given subscriber's subscription list 312a immediately upon request by a user. As described above, because storage space is one aspect which is desired to be economized by not processing unneeded data, the event notification service 310 filters events 302 as it receives the events 302 in order to discard unneeded (i.e., unsubscribed to) data. However, when a subscriber 390a requests a subscription change that results in a need to enable handling and storage of particular events or event fields that had been previously disabled, the event notification service 310 may have no way to “un-discard” the previously discarded data that would be associated with any data that is still in the data model. Therefore, it may be desirable to add intelligence to either the user interface 395a, the formatter 390a, and/or the event notification service 310 which would choose an appropriate point in the stream of events 302 to turn on (i.e., stop discarding) the newly desired event data. Thus, it may be desirable that the turn-on of data should not be allowed to happen at just any random place, but rather be held off to happen between predefined junctions in the event data stream.

For example, event data 302 may be streamed according to an organized hierarchy or tree structure, which contains conceptual chains of dependency that go from the more numerous “leafward” parts of the tree structure toward the “trunkward” parts of the tree that they use for context information. Thus, at least one of the particular user interface, its formatter, and/or the event notification service would include functionality for determining when, or at which point in the event stream, to apply requested subscription updates. Furthermore, there may be situations where even though a certain item in the tree doesn't have any subscribers for the data that it contains, there may still be a need for some (possibly smaller) object to be placed into the data model tree in its place in the subscriber's database so that the expected tree structure expected by the particular user interface is preserved.

Those of skill in the art will appreciate that the invented method and apparatus described and illustrated herein may be implemented in software, firmware, hardware, or any suitable combination thereof. In this regard, embodiments may be implemented as program instructions stored on a computer-readable medium and configured to be executed by any suitable instruction processor. Embodiments may also be a computer which executes software implementing the functionality described above. Embodiments may also be entire systems including the event-generating device, the event notification service, and subscribers. Alternative embodiments are contemplated, however, and are within the spirit and scope of the invention.

What is claimed is:

1. An event notification system, comprising:
a subscription manager which keeps track of respective subscriptions of at least one subscriber, the subscription manager configured to receive a subscription update request from a requesting subscriber and to update the respective subscription associated with the requesting subscriber with a requested subscription;
an event monitor which receives an event; and
an event notifier configured to notify any subscribers having a subscription to the received event.

2. The event notification service system of claim 1, comprising:
an event store which stores only subscribed-to events.

3. The event notification system of claim 1, wherein the event notifier sends the event to a subscriber when notifying the subscriber of the event.

4. The event notification system of claim 1, wherein the event notifier sends an event notification message to a subscriber when notifying the subscriber of the event, the event notification message indicating that the event subscribed to by the subscriber is available for retrieval.

5. The event notification system of claim 1, wherein:
event data of received events that is not subscribed to by any subscribers is discarded.

6. The event notification service of claim 1, wherein the subscription manager dynamically processes subscription update requests to enable processing and storage of events that is indicated in a received subscription update request as being subscribed to, and to disable processing and storage of event data that is indicated in the received subscription update request as being no longer subscribed to.

7. The event notification service of claim 6, wherein the subscription manager processes the received subscription update request after initial registration of a requesting subscriber with the event notification service.

8. A method for allowing dynamic subscription updates by an event notification service, comprising:
maintaining respective subscriptions of at least one subscriber;
receiving a subscription update request from a requesting subscriber;
updating the respective subscription associated with the requesting subscriber with a requested subscription update.

9. The method of claim 8, comprising:
receiving an event;
notifying any subscribers having a subscription to the received event.

10. The method of claim 8, comprising:
discarding unused event data to which no subscriber has a subscription.

11. The method of claim 8, wherein the updating step comprises:
dynamically enabling processing and storage of event data that is indicated in the subscription update request as being subscribed to; and
dynamically disabling processing and storage of event data that is indicated in the subscription update request as being no longer subscribed to.

12. The method of claim 11, wherein the updating step is performed after initial registration of a requesting subscriber with the event notification service.

13. A computer readable storage medium tangibly embodying program instructions, which when executed by a computer, implements a method for allowing dynamic subscription updates by an event notification service, the method comprising the steps of:
maintaining respective subscriptions of at least one subscriber;
receiving a subscription update request from a requesting subscriber;
updating the respective subscription associated with the requesting subscriber with a requested subscription update.

14. The computer readable storage medium of claim 13, the method comprising:
receiving an event;
notifying any subscribers having a subscription to the received event.

15. The computer readable storage medium of claim 13, the method comprising:
discarding unused event data to which no subscriber has a subscription.

16. The computer readable storage medium of claim 13, wherein the updating step comprises:
dynamically enabling processing and storage of event data that is indicated in the subscription update request as being subscribed to; and
dynamically disabling processing and storage of event data that is indicated in the subscription update request as being no longer subscribed to.

17. The computer readable storage medium of claim 13, wherein the updating step is performed after initial registration of a requesting subscriber with the event notification service.
